(19) United States
(12) Patent Application Publication
(10) Pub. No.: US 2006/0188629 A1
(43) Pub. Date: Aug. 24, 2006

(54) Method for the purification of sucralose

(76) Inventors: Greg Liesen, Mechanicsville, VA (US); Sunil Srivastava, Oak Brook, IN (US)

Correspondence Address: WALLENSTEIN & WAGNER, LTD., 311 SOUTH WACKER DRIVE, 53RD FLOOR, CHICAGO, IL, 60606, US

(21) Appl. No.: 11/336,399

(22) Filed: Jan. 20, 2006

Related U.S. Application Data
(60) Provisional application No. 60/645,984, filed on Jan. 21, 2005.

(51) Int. Cl. A23L 1/236

(52) U.S. Cl. 426/548

(57) ABSTRACT

This invention relates to the purification of sucralose by contacting a mixture containing crude sucralose with organic and/or aqueous organic solvents. The mixture may be crystallized from aqueous organic solvents using pure sucralose seed crystals.

### CROSS-REFERENCE TO RELATED APPLICATIONS

This application claims priority to U.S. Provisional Patent Application No. 60/645,984, filed Jan. 21, 2005, which is incorporated herein by reference and made a part hereof.

### FEDERALLY SPONSORED RESEARCH OR DEVELOPMENT

Not applicable.

### TECHNICAL FIELD

This invention relates to a method for the purification of sucralose.

### BACKGROUND OF THE INVENTION

Sucralose, 4,1′,6′-trichloro-4,1′,6′-trideoxygalactosucrose, is a high potency carbohydrate sweetener (about 400-800X sweeter than sucrose) that has the formula

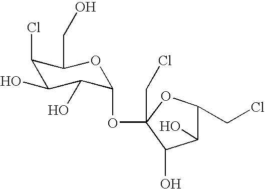

Sucralose, a particularly useful sweetening agent, is derived from sucrose by replacing the hydroxyl groups in the 4, 1′, and 6′ positions with chlorine. Synthesis of sucralose is technically challenging because of the need to selectively replace specific hydroxyl groups with chlorine atoms, while preserving other hydroxyl groups including a highly reactive primary hydroxyl group. Numerous approaches to this synthesis have been developed. The synthesis of sucralose is disclosed in U.S. Pat. Nos. 4,405,654; 4,362,869; 4,826,962; 4,980,463; and 5,141,860, which are expressly incorporated by reference herein. However, such approaches typically provide a product that contains varying levels of other chlorinated sugar compounds in addition to sucralose. Impurities includes any monochloro-, dichloro-, tetrachloro-, and pentachloro-derivative of sucrose and any other disaccharide derived from sucrose, as well as any trichloro-derivative other than sucralose itself, whether present in free form or as esters of carboxylic acids. Other impurities includes any of the halogenated sugar derivatives, such as dichlorosucrose acetate, 6,1′,6′-trichlorosucrose, 4,6,6′-trichlorosucrose, 4,1′,4′,6′-tetrachlorogalactotagatose, 4,1′,6′-trichlorogalactosucrose-6-acetate, 4,6,1′,6′-tetrachlorogalactosucrose, 4,1′-dichlorogalactosucrose, 3′,6′-dichloroanhydrosucrose, 4,6′-dichlorogalactosucrose, 1′,6′-dichlorosucrose, 6,6′-dichlorosucrose, 4,1′,6′-trichlorosucrose, 4,6,6′-trichlorogalactosucrose, 4,1′,5′-trichlorogalactosucrose-6-acetate, and 4,6,6′-trichlorogalactosucrose-rose. Sucralose may also include organic or inorganic salt, carbohydrate, or acylated sucralose impurities.

Although much effort has been directed toward the synthesis of sucralose, the isolation of sucralose in highly pure form from this complex mixture of contaminants heretofore has received relatively little attention. Early reported work typically involved crystallizing sucralose directly from the synthesis mixture, a process that yields a material with high impurity levels. Sucralose is sometimes purified from a synthesis mixture by silica gel chromatography. See, e.g., U.S. Pat. No. 5,128,248, which is expressly incorporated by reference herein. That procedure, due to its use of silica gel, may be ill-suited to large-volume commercial production of highly pure sucralose. In addition, relatively little attention has been focused on other approaches for removing halogenated sugar impurities from sucralose. Efficient removal of these impurities is important because, as generally discussed in U.S. Pat. No. 5,510,508 and U.S. Pat. No. 5,728,862, the disclosure of each of which is incorporated by reference herein, even at quite low concentrations, they can have an adverse impact on the sweetness, taste, and flavor-modifying properties of sucralose.

U.S. Pat. No. 5,498,709 describes the process involves the toluene extraction of the alkaline solution remaining after deesterification. Specifically, the solution is extracted twice with toluene to remove non-polar impurities. The aqueous solution is then extracted repeatedly with 2-butanone. The 2-butanone extracts are combined, and the solvent is evaporated to yield a reddish syrup containing sucralose.

U.S. Pat. No. 5,530,106 relates to an extractive process for a crude sucralose solution obtained after alkaline hydrolysis of sucralose-6-acetate and subsequent neutralization. The aqueous sucralose solution is extracted with water saturated ethyl acetate. Some impurities are selectively partitioned to the organic phase by this extraction. Subsequently, the ethyl acetate phase is backwashed with water in order to recover a portion of the sucralose that had also partitioned into the organic phase. The aqueous solution and the aqueous backwash are combined, concentrated, decolorized, and the sucralose is recovered by crystallization from the aqueous phase.

U.S. Patent Appln. No. 20030171574 relates to extractive methods for purifying sucralose. Steam distillation is used to remove dimethyl formamide. Then, less polar impurities are removed by liquid-liquid extraction with ethyl acetate. Ethyl acetate is backwashed with water. Aqueous layer and water washes are combined and crystallized.

U.S. Patent Appln. No. 20030171575 relates to processes for purifying sucralose by the use of an initial non-crystallization purification procedure followed by three or more sequential crystallization steps and recycle of the mother liquor remaining from each crystallization step to the feed of another crystallization or purification step.

The present invention is provided to solve the problems discussed above and other problems, and to provide advantages and aspects not provided by prior purification methods of this type. A full discussion of the features and advantages of the present invention is deferred to the following detailed description.

### SUMMARY OF THE INVENTION

In one embodiment of the present invention, a process for purifying a sucralose mixture is provided. The process includes contacting the sucralose mixture with an alcohol solution to form a first increased purity sucralose solution; and thereafter contacting the first increased purity sucralose solution with an aqueous-organic solution to form a second increased purity sucralose solution. Polar impurities and non-polar impurities comprise less than 3% of the second increased purity sucralose solution.

In another embodiment of the present invention, the process for purifying a sucralose mixture also includes crystallizing the second increased purity sucralose solution to form crystalline sucralose. The crystalline sucralose is at least 99% pure sucralose.

In yet another embodiment of the present invention, a process for crystallizing partially purified sucralose is provided. The process includes adding an aqueous organic solvent to the partially purified sucralose to form a reaction mixture; maintaining the reaction mixture at a temperature of between 40 and 90° C.; and cooling the reaction mixture to a temperature of between 15 and 30° C. The process also includes seeding the reaction mixture at a temperature between 30° C. to 5° C. with an amount of pure crystalline sucralose; cooling the reaction mixture to a temperature of about 0-15° C. over 0.5 hours to 24 hours; and holding the reaction mixture at a temperature of about 0-15° C. over 0.5 hours to 24 hours to result in greater than 99% pure sucralose. The amount of pure crystalline sucralose is from 0.0001% to 10% of the amount of sucralose by weight in the reaction mixture during the seeding step.

Other features and advantages of the invention will be apparent from the following specification.

### DETAILED DESCRIPTION

While this invention is susceptible of embodiments in many different forms, there will herein be described in detail preferred embodiments of the invention with the understanding that the present disclosure is to be considered as an exemplification of the principles of the invention and is not intended to limit the broad aspect of the invention to the embodiments illustrated.

The present invention aids in the purification of sucralose. A crude sucralose solution for purification is provided. In one embodiment, the crude sucralose solution contains 85-92% sucralose by weight. According to one embodiment of the present invention, the crude sucralose solution contacts an alcohol solvent. The solvent is separated from a first intermediate mixture to form a first improved purity sucralose solution. The first improved purity sucralose solution contacts an aqueous organic solvent. The aqueous organic solvent is separated to form a second improved purity sucralose solution. The second improved purity sucralose solution is crystallized using pure sucralose seeds to form crystalline sucralose.

The aforementioned process purifies by removing numerous impurities, including for example dichlorosucrose acetate, 6,1′,6′-trichlorosucrose, 4,6,6′-trichlorosucrose, 4,1′,4′,6′-tetrachlorogalactotagatose, 4,1′,6′-trichlorogalactosurcrose-6-acetate, 4,6,1′,6-tetrachlorogalactosucrose, 4,1′-dichlorogalactosucrose, 3′,6′-dichloroanhydrosucrose,4,6′-dichlorogalactosucrose, 1′,6′-dichlorosucrose, 6,6′-dichlorosucrose, 4,1′,6′-trichlorosucrose, 4,6,6′-trichlorogalactosucrose, 4,1′,5′-trichlorogalactosucrose-6-acetate, and 4,6,6′-trichlorogalactosucrose from crude reaction mixtures of sucralose.

As described herein, the step of contacting crude syrupy sucralose with an alcoholic solvent e.g. methanol, ethanol, propanol, isopropanol, butanol, tert-butanol to remove the polar impurities and then with a mixture of water and immiscible organic solvent in an amount up to about 10-50% by weight, e.g., tert butyl methyl ether, ethyl acetate, diethyl ether, methyl acetate, butyl acetate, propyl acetate, isopropyl acetate, cyclohexane, acetone, acetonitrile, heptane, pentane, dichloromethane, chloroform, toluene, xylene and mixtures thereof, can be carried out by adding aqueous organic solvent to the syrupy crude sucralose. This step of the process reduces polar and non-polar impurities. Contacting the crude syrupy sucralose with the alcohol solvent may be done by stirring. In one embodiment, stirring crude syrupy sucralose in the alcohol solvent may form a slurry.

Generally the alcoholic solvent stirring is conducted at 20-25° C. for a time of about 0.5 to about 30 hours. The resulting first intermediate mixture is then decanted or otherwise separated to leave a first improved purity sucralose solution. The first improved purity sucralose solution is typically 92-95% pure. In some cases, the purity of the first improved purity sucralose solution will be sufficient. However, further purification is often desired.

In one embodiment, the first improved purity sucralose solution is contacted with an aqueous organic solvent. Contacting the first improved purity sucralose solution with an aqueous organic solution may be done by stirring. Generally, the aqueous organic stirring is conducted at a temperature in a range of about 10° C. to about 90° C. for a time of about 0.5 to about 30 hours. In one embodiment, stirring the first improved purity sucralose solution in the aqueous organic solvent may form a slurry. After the aqueous organic solvent has sufficiently contacted the first improved purity sucralose solution, the partially purified sucralose syrup is typically separated from the aqueous layer by concentration or evaporation to form a second improved purity sucralose solution. The second improved purity sucralose solution is typically 97-99% pure. The second improved purity sucralose solution is in the form of a syrup and not a powder. In some cases, further purifications or crystallization will be desired.

The contacting of the first improved purity sucralose solution and aqueous organic solvent is formed by combining the aqueous organic solvent and first improved purity sucralose solution in any desirable manner for a specific time. It is preferable to stir the mixture. Typically, the mixture is held at a temperature of about 15° C. to about 45° C. for a time of about 0.5 to about 30 hours. The mixture is then decanted or centrifuged to recover the partially purified sucralose or second improved purity sucralose solution.

The second improved purity sucralose solution is then purified via crystallization which can be optimized in order to produce substantially pure crystals of sucralose.

It has been found that sucralose in aqueous organic solvent has a wide meta-stable crystallization zone which inhibits rapid nucleation. Seeding during crystallization can initiate a controlled crystal growth rate according to the present invention. Regardless, the same type of crystals are obtained over a wide range of conditions (e.g., static, stirred, evaporative, slow cooling, and precipitation by non-polar solvent addition).

The crystallization of the present invention can be performed via slow cooling.

According to the embodiment of the present invention, an aqueous organic solvent, such as ethyl acetate in water, is added to partially purified sucralose and is held for a time and at a temperature sufficient to form a solution, and then the solution is seeded. For example, the solution may be heated to and maintained at a temperature of between 40 and 90° C. The aqueous organic solvent of the crystallization may be the same or different from the aqueous organic solvent which contacts the first improved purity sucralose solution. Finally, the solution is slowly cooled to crystallize pure sucralose.

The reaction mixture is seeded in an amount from 0.0001%-10%, by weight, of the pure crystalline sucralose in the solution. Preferably this amount is from 0.00%-1%, more preferably this amount is from 0.1% to 1%, and most preferably this amount is from 0.1% to 0.5%. Seeding can occur between 5° C. and 30° C., preferably between 25° C.-30° C. After seeding, the sucralose is between 99-100% pure.

According to this method, the reaction mixture is generally cooled to a temperature of from about 5° C. to about 25° C. Crystallization preferably occurs by ramping the temperature after seeding to 5° C. over a time range of 0.5 to 24 hours. The seeding process can be repeated to further purify the sucralose.

Generally, lower seed and faster ramp gives larger crystals and slightly higher yields. Lesser seed also generally gives more uniformly sized crystals. The crystals are generally white in color. The pure crystalline sucralose are optionally filtered. It is contemplated that the filtered sucralose may be washed to recover further purified crystalline sucralose.

It should also be noted that higher alcohol/water concentration during crystallization at lower temperatures results in higher purity sucralose in high yield.

In additional embodiments of the present invention, organic solvents other than methanol may be used to crystallize partially purified sucralose. Such alternate organic solvents include, without limitation, ethanol/water, propanol/water, isopropanol/water, butanol/water, t-butanol/water, tert butyl methyl ether (MTBE), diethylether, acetone/hexane, acetonitrile/hexane, acetonitrile/heptane, acetonitrile/pentane, methanol/heptane, ethanol/hexane, isopropanol/hexane, methanol/hexane, butanol/hexane, dichloromethane/hexane or chloroforn/hexane.

According to the present invention, the desired solvent concentration is generally between 5-70% by weight.

In a preferred embodiment of the present invention, the desired solvent concentration is between 40-50% by weight.

Further, in accordance with the present invention, the reaction mixture is held for a time and temperature. The reaction mixture is generally held for 1-20 hours at a temperature of 0° C.-20° C. In a preferred embodiment of the present invention, the reaction mixture is held for 8-16 hours.

The reaction mixture or the solution containing sucralose may be unstirred or stirred during the crystallization processes of the present invention.

The product isolated from any of these crystallization methods using standard filteration or centrifugation techniques.

In one preferred embodiment, crude sucralose containing 85-92% sucralose can be purified to appropriately 92-96% pure by use of the alcohol solvent, to approximately 97-99% by use of the aqueous organic solvent, and to between 99-100% pure by use of crystallization of the present invention.

The Examples which follow are intended as an illustration of certain preferred embodiments of the invention, and no limitation of the invention is implied. Examples 2-5 are theoretical examples intended to demonstrate the present invention.

### EXAMPLE 1

To a crude syrupy sucralose reaction mixture (10 g) containing 85-92% (by wt.) of sucralose was added methanol (10 mL). The mixture was stirred at room temperature for 2 hours. The mixture was decanted. This step removes polar impurities. The residual crude sucralose was stirred in dichloromethane, water and t-butyl methyl ether (10 mL, 1:1:1 by volume). The mixture was heated to 60° C. for 30 minutes. After cooling to room temperature, the aqueous layer containing sucralose was separated. The sucralose is in the water layer. This step removes mainly non-polar impurities. To the aqueous solution containing sucralose were added water and ethyl acetate (6.3 and 10 mL respectively). The mixture was stirred at room temperature for 24 hours. The mixture was allowed to stand for 30 minutes and then the organic solvent was decanted. This step also removes non-polars. The aqueous layer was evaporated under reduced pressure at 40-50° C. to get syrup. The process improves the purity of sucralose to 97-99%, but the product is still syrupy. To this partially purified sucralose syrup was added a volume of methanol equal to the volume of water (10 mL, 1:1 by volume). The mixture was heated to 60° C. for 30 minutes until a clear solution was obtained. After cooling the solution to 25° C., crystallization was initiated by seeding with 0.01 g of pure sucralose crystals. The solution was then cooled with agitation to 5° C. over two hours. After holding at 5° C. for 12 hours, the crystal mass was broken up with a glass rod and filtered. The cake was washed with cold water: methanol. The wet product was dried at 40-50° C. under house vacuum with a nitrogen purge for 18 hours to give 8.6 g of sucralose.

### EXAMPLE 2

To a crude syrupy sucralose reaction mixture (10 g) containing 85-92% (by wt.) of sucralose was added methanol (10 mL). The mixture was stirred at room temperature for 2 hours. The mixture was decanted. This step removes polar impurities. To the residual crude syrupy sucralose reaction mixture (10 g) containing 85-92% (by wt.) of sucralose was added water: ethyl acetate (10 mL, 1:1 by volume). The mixture was stirred at room temperature for 24 hours. The mixture was allowed to stand for 30 minutes and then the aqueous organic solvent was decanted. The process improves the purity of sucralose to 97-99% but the product is still syrupy. To this partially purified sucralose syrup was added water: ethyl acetate (20 mL, 1:1 by volume). The mixture was heated to 60° C. for 30 minutes until a clear solution was obtained. After cooling the solution to 25° C., crystallization was initiated by seeding with 0.01 g of pure sucralose crystals. The solution was then cooled with no agitation to 5° C. over two hours. After holding at 5° C. for 12 hours, the crystal mass was broken up with a glass rod and filtered. The cake was washed with cold water: ethyl acetate (10 mL, 1:1 by volume) (1.time, 5 ml). The wet product was dried at 40-50° C. under house vacuum with a nitrogen purge for 18 hours to give 8.1 g of sucralose.

### EXAMPLE 3

To a crude syrupy sucralose reaction mixture (10 g) containing 85-92% (by wt.) of sucralose was added methanol (10 mL). The mixture was stirred at room temperature for 2 hours. The mixture was decanted. This step removes polar impurities. To the residual crude syrupy sucralose reaction mixture (10 g) containing 85-92% (by wt.) of sucralose was added water: toluene (10 mL, 1:1 by volume). The mixture was stirred at room temperature for 24 hours. The mixture was allowed to stand for 30 minutes and then the aqueous organic solvent was decanted. The process improves the purity of sucralose to 97-99% but the product is still syrupy. To this partially purified sucralose syrup was added water: toluene (20 mL, 1:1 by volume). The mixture was heated to 60° C. for 30 minutes until a clear solution was obtained. After cooling the solution to 25° C., crystallization was initiated by seeding with 0.01 g of pure sucralose crystals. The solution was then cooled with agitation to 5° C. over two hours. After holding at 5° C. for 12 hours, the crystal mass was broken up with a glass rod and filtered. The cake was washed with cold water: ethyl acetate (10 mL, 1:1 by volume) (1.time, 5 ml). The wet product was dried at 40-50° C. under house vacuum with a nitrogen purge for 18 hours to give 8.6 g of sucralose.

### EXAMPLE 4

To a crude syrupy sucralose reaction mixture (10 g) containing 85-92% (by wt.) of sucralose was added methanol (10 mL). The mixture was stirred at room temperature for 2 hours. The mixture was decanted. This step removes polar impurities. To the residual crude syrupy sucralose reaction mixture (10 g) containing 85-92% (by wt.) of sucralose was added water: methyl tert butyl ether (10 mL, 1:1 by volume). The mixture was stirred at room temperature for 24 hours. The mixture was allowed to stand for 30 minutes and then the aqueous organic solvent was decanted. The process improves the purity of sucralose to 97-99% but the product is still syrupy. To this partially purified sucralose syrup was added water: methyl tert butyl ether (20 mL, 1:1 by volume). The mixture was heated to 60° C. for 30 minutes until a clear solution was obtained . After cooling the solution to 25° C., crystallization was initiated by seeding with 0.01 g of pure sucralose crystals. The solution was then cooled with no agitation to 5° C. over two hours. After holding at 5° C. for 12 hours, the crystal mass was broken up with a glass rod and filtered. The cake was washed with cold water: ethyl acetate (10 mL, 1:1 by volume) (1×5 ml). The wet product was dried at 40-50° C. under house vacuum with a nitrogen purge for 18 hours to give 8.3 g of sucralose.

### EXAMPLE 5

To a crude syrupy sucralose reaction mixture (10 g) containing 85-92% (by wt.) of sucralose was added methanol (10 mL). The mixture was stirred at room temperature for 2 hours. The mixture was decanted. This step removes polar impurities. To the residual crude syrupy sucralose reaction mixture (10 g) containing 85-92% (by wt.) of sucralose was added water: ethyl acetate (10 mL, 1:1 by volume). The mixture was stirred at room temperature for 24 hours. The mixture was allowed to stand for 30 minutes and then the aqueous organic solvent was decanted. The process improves the purity of sucralose to 97-99% but the product is still syrupy. To this partially purified sucralose syrup was added water (12 mL). The mixture was heated to 60° C. for 30 minutes until a clear solution was obtained. After cooling the solution to 25° C., crystallization was initiated by seeding with 0.01 g of pure sucralose crystals. The solution was then cooled with no agitation to 5° C. over two hours. After holding at 5° C. for 12 hours, the crystal mass was broken up with a glass rod and filtered. The cake was washed with cold water (2 mL,) (1.time, 5 ml). The wet product was dried at 40-50° C. under house vacuum with a nitrogen purge for 18 hours to give 8.0 g of sucralose.

Other variations or modifications, which will be obvious to those skilled in the art, are within the scope and teachings of this invention. This invention is not to be limited except as set forth in the following claims.

While the specific embodiments have been illustrated and described, numerous modifications come to mind without significantly departing from the spirit of the invention, and the scope of protection is only limited by the scope of the accompanying Claims.

What is claimed is:

1. A process for purifying a sucralose mixture comprising sucralose, polar impurities and non-polar impurities, the process comprising the steps of:
removing at least a portion of the polar impurities in the sucralose mixture by mixing the sucralose mixture with an alcohol solution;
removing at least a portion of the non-polar impurities in a one or more step purification procedure comprising mixing the sucralose mixture with an aqueous-organic solvent mixture to yield an increased purity sucralose mixture; and,
crystallizing with seeding on the increased purity sucralose solution to obtain crystalline sucralose.

2. The process of claim 1, wherein the step of removing at least a portion of the polar impurities comprises a non-crystallization purification procedure comprising stirring in an alcohol solvent.

3. The process according to claim 1, wherein the stirring of the step of removing at least a portion of the polar impurities is conducted at a temperature of about 10° C. to about 90° C.

4. The process according to claim 1, wherein the stirring of the step of removing at least a portion of the polar impurities is conducted for a time of about 0.5 to about 30 hours.

5. The process according to claim 1, wherein the sucralose mixture is held at a temperature of about 15° C. to about 45° C.

6. The process according to claim 1, wherein the alcohol solution is selected from the group consisting of methanol, ethanol, propanol, isopropanol, butanol, tert-butanol and mixtures thereof.

7. The process of claim 1, wherein the step of removing at least a portion of the non-polar impurities comprises a non-crystallization purification procedure comprising stirring in a mixture organic and aqueous solvents.

8. The process according to claim 1, wherein the stirring of the step of removing at least a portion of the non-polar impurities is conducted at a temperature of about 10° C. to about 90° C.

9. The process according to claim 1, wherein the stirring of the step of removing at least a portion of the non-polar impurities is conducted for a time of about 0.5 to about 30 hours.

10. The process according to claim 1, wherein the sucralose mixture is held at a temperature of about 15° C. to about 45° C.

11. The process according to claim 1, wherein the aqueous organic solvent mixture comprises an organic solvent, the organic solvent is selected from the group consisting of tert butyl methyl ether, ethyl acetate, diethyl ether, methyl acetate, butyl acetate, propyl acetate, isopropyl acetate, cyclohexane, acetone, acetonitrile, heptane, pentane, dichloromethane, chloroform, toluene, xylene and mixtures thereof.

12. The process according to claim 1, wherein the step of crystallizing comprises:
adding an aqueous organic solvent to the partially purified sucralose;
heating the reaction mixture to 40-90° C.;
cooling the crystallization mixture to 15-30° C.;
seeding the reaction mixture at a temperature between 30° C. to 5° C. with an amount of pure crystalline sucralose from 0.0001% to 10% by weight based on the amount of sucralose in the crystallization mixture;
cooling the reaction mixture to a temperature of about 0-15° C. over 0.5 hours to 24 hours in order to initiate crystallization of pure sucralose; and,
holding the reaction mixture to a temperature of about 0-15° C. over 0.5 hours to 24 hours to final crystallization.

13. The process according to claim 12, wherein said aqueous organic solvent comprises an organic solvent, the organic solvent is selected from the group consisting of methanol, ethanol, propanol, isopropanol, butanol, tert-butanol chloroform, tert butyl methyl ether, ethyl acetate, diethyl ether, methyl acetate, butyl acetate, propyl acetate, isopropyl acetate, cyclohexane, acetone, acetonitrile, heptane, pentane, dichloromethane, chloroform, toluene, xylene and mixtures thereof.

14. The process according to claim 13, wherein the organic solvent is methanol.

15. The process according to claim 13, wherein the step of seeding the reaction mixture is performed at a temperature between 30° C. to 20° C.

16. The process according to claim 12, wherein the step of seeding the reaction mixture comprises seeding with an amount of sucralose from 0.001% to 1% by weight based on the amount of sucralose present in the crystallization mixture.

17. The process according to claim 13, wherein the reaction mixture of the step of seeding the reaction mixture is held at 30° C. to 5° C. for 0.5 hours to 24 hours.

18. The process according to claim 13, wherein the reaction mixture of the step of cooling the reaction mixture is stirred or unstirred.

19. The process of claim 1, wherein the polar and non-polar impurities comprise one or more impurities selected from the group consisting of 4,6′-dichlorogalactosucrose, 4,1′-dichlorogalactosucrose, 1′,6′-dichlorosucrose, 3′,6′-anhydro-4,1-dichlorogalactosucrose, 4,1′,6′-trichlorogalactosucrose-6-acetate, and 6,1′,6′-trichlorosucrose.

20. The process of claim 12, wherein the crystalline sucralose is greater than 99% pure and is crystalline.

21. A process for purifying a sucralose mixture comprising sucralose, polar impurities and non-polar impurities, the process comprising:
contacting the sucralose mixture with an alcohol solution to form a first increased purity sucralose solution; and,
contacting the first increased purity sucralose solution with an aqueous-organic mixture to form a second increased purity sucralose solution, wherein the polar and non-polar impurities comprise less than 3% of the second increased purity sucralose solution.

22. The process according to claim 21, wherein the sucralose mixture is between 85 and 92% sucralose by weight.

23. The process according to claim 21, wherein the first increased purity sucralose solution comprises between 92 and 96% sucralose by weight.

24. The process according to claim 21, further comprising crystallizing the second increased purity sucralose solution to form crystalline sucralose, the crystalline sucralose comprising at least 99% sucralose.

25. The process according to claim 21, wherein the contacting the sucralose mixture with an alcohol solution step comprises stirring the sucralose mixture with an alcohol solution to form a first intermediate mixture, and recovering the first increased purity sucralose solution from the first intermediate mixture.

26. The process according to claim 25, wherein the stirring the sucralose mixture step is performed at a temperature of about 10° C. to about 90° C.

27. The process according to claim 25, wherein the stirring the sucralose mixture step is performed between about 0.5 to about 30 hours.

28. The process according to claim 25, wherein the recovering the first increased purity sucralose solution step comprises decanting the first intermediate mixture.

29. The process according to claim 21, wherein the alcohol solution is selected from the group consisting of methanol, ethanol, propanol, isopropanol, butanol, and tert-butanol mixtures thereof.

30. The process according to claim 25, wherein the stirring the sucralose mixture step forms a slurry.

31. The process according to claim 25, wherein the contacting the first increased purity sucralose solution with an aqueous organic mixture step comprises stirring the first increased purity sucralose solution with the aqueous organic mixture to form a second intermediate mixture, and recovering the second increased purity sucralose solution from the second intermediate mixture.

32. The process according to claim 31, wherein the stirring the first increased purity sucralose solution step is performed between about 0.5 to about 30 hours.

33. The process according to claim 31, wherein the recovering the second improved purity sucralose solution step comprises decanting the second intermediate mixture.

34. The process according to claim 31, wherein the stirring the first increased purity sucralose solution step forms a slurry.

35. The process according to claim 21, wherein the aqueous organic mixture is selected from the group consisting of tert butyl methyl ether, ethyl acetate, diethyl ether, methyl acetate, butyl acetate, propyl acetate, isopropyl acetate, cyclohexane, acetone, acetonitrile, heptane, pentane, dichloromethane, chloroform, toluene, xylene and mixtures thereof.

36. The process according to claim 21, wherein said the sucralose mixture comprises one or more impurities selected from the group consisting of 4,6′-dichlorogalactosucrose, 4,1′-dichlorogalactosucrose, 1′,6′-dichlorosucrose, 3′,6′-anhydro-4,1-dichlorogalactosucrose, 4,1′,6′-trichlorogalactosucrose-6-acetate, and 6,1′,6′-trichlorosucrose.

37. The process according to claim 21, wherein the contacting the sucralose mixture with an alcohol solution step removes polar impurities.

38. The process according to claim 21, wherein the contacting the first improved purity sucralose solution with an aqueous organic solution step removes non-polar impurities.

39. A process for crystallizing partially purified sucralose, the process comprising:
adding an aqueous organic solvent to the partially purified sucralose to form a reaction mixture;
maintaining the reaction mixture at a temperature of between 40 and 90° C.;
cooling the reaction mixture to a temperature of between 15 and 30° C.;
seeding the reaction mixture at a temperature between 30° C. to 5° C. with an amount of pure crystalline sucralose, the amount of pure crystalline sucralose being from 0.0001% to 10% of the amount of sucralose by weight in the reaction mixture during the seeding step;
cooling the reaction mixture to a temperature of about 0-15° C. over 0.5 hours to 24 hours; and,
holding the reaction mixture at a temperature of about 0-15° C. over 0.5 hours to 24 hours to form greater than 99% pure sucralose.

40. The process according to claim 39, wherein the partially purified sucralose comprises at least 97% sucralose by weight.

41. The process according to claim 39, wherein said aqueous organic solvent comprises an organic solvent, the organic solvent is selected from the group consisting of methanol, ethanol, propanol, isopropanol, butanol, tert-butanol, tert butyl methyl ether, ethyl acetate, diethyl ether, methyl acetate, butyl acetate, propyl acetate, isopropyl acetate, cyclohexane, acetone, acetonitrile, heptane, pentane, dichloromethane, chloroform, toluene, xylene and mixtures thereof.

42. The process according to claim 39, wherein the organic solvent is methanol.

43. The process according to claim 39, wherein the seeding the reaction mixture step occurs at a temperature between 20° C. to 30° C.

44. The process according to claim 39, wherein the amount of pure crystalline sucralose is between 0.001% to 1% of sucralose by weight in the reaction mixture during the seeding step

45. The process according to claim 39, wherein the seeding the reaction mixture step is performed at 30° C. to 5° C. for 0.5 hours to 24 hours.

46. The process according to claim 39, wherein the cooling the reaction mixture step comprises stirring the reaction mixture.

47. The process according to claim 39, wherein the cooling the reaction mixture step comprises cooling the reaction mixture without stirring.

48. The process according to claim 39, wherein the greater than 99% pure sucralose is crystalline.

49. The process according to claim 39, further comprising filtering the greater than 99% pure sucralose.

50. A process for purifying a sucralose mixture comprising sucralose, polar impurities and non-polar impurities, the process comprising:
contacting the sucralose mixture with an alcohol solution to form an increased purity sucralose solution; and,
crystallizing the increased purity sucralose solution to form crystalline sucralose comprising at least 99% sucralose.

51. A process for purifying a sucralose mixture comprising sucralose, polar impurities and non-polar impurities, the process comprising:
contacting the sucralose mixture with an aqueous-organic mixture to form an increased purity sucralose solution; and,
crystallizing the increased purity sucralose solution to form crystalline sucralose comprising at least 99% sucralose.
